(19) United States
(12) Patent Application Publication
(10) Pub. No.: US 2011/0320252 A1
(43) Pub. Date: Dec. 29, 2011

(54) Apparatus and Method for Redeeming an Incentive on a Wireless Device

(75) Inventors: Raghu Sastry, San Jose, CA (US); Jae Kim, Pleasanton, CA (US); Christopher J. Sweis, Elk Grove Village, IL (US)

(73) Assignee: MOBILE MEDIA SOLUTIONS, INC., Elk Grove Village, IL (US)

(21) Appl. No.: 13/168,898

(22) Filed: Jun. 24, 2011

Related U.S. Application Data
(60) Provisional application No. 61/358,395, filed on Jun. 24, 2010.

(51) Int. Cl. G06Q 30/00

(52) U.S. Cl. 705/14.23

(57) ABSTRACT

A non-transitory computer readable storage medium includes executable instructions to collect a first wireless internet protocol address associated with a wireless client device that initiates an invoked offer. The first wireless internet protocol address is associated with incentive identification information corresponding to the invoked offer. An application invocation page is delivered to the wireless client device. Log in information is received from the wireless client device. A second wireless internet protocol address accompanying the log in information is collected. The incentive identification information is retrieved if the first wireless internet protocol address matches the second internet protocol address. An incentive specified by the incentive identification information is then downloaded to the wireless client device.

### CROSS-REFERENCE TO RELATED APPLICATION

This application claims priority to U.S. Provisional Patent Application 61/358,395, filed Jun. 24, 2010, entitled “Affiliate Tracking Advertising Program”, the contents of which are incorporated herein.

### FIELD OF THE INVENTION

This invention relates generally to the distribution and redemption of electronic incentives (e.g., electronic coupons or credits). More particularly, this invention relates to the utilization of a wireless device to redeem an electronic incentive.

### BACKGROUND OF THE INVENTION

As consumers gravitate toward the use of wireless devices (e.g., smart phones, personal digital assistants, and the like) to manage their personal affairs, there is a growing demand for reaching such consumers through their wireless devices. Offers (e.g., advertisements, coupons and other incentives) to consumers are more likely to be utilized if they can be accessed on impulse with minimal input from a user. While retailers are always looking to access more consumers, they are not always in a position to expend resources on equipment that may facilitate consumer interactions, such as point of sale equipment.

Accordingly, it would be desirable to provide to consumers and retailers improved techniques for redeeming electronic based incentives.

### SUMMARY OF THE INVENTION

A non-transitory computer readable storage medium includes executable instructions to collect a first wireless internet protocol address associated with a wireless client device that initiates an invoked offer. The first wireless internet protocol address is associated with incentive identification information corresponding to the invoked offer. An application invocation page is delivered to the wireless client device. Log in information is received from the wireless client device. A second wireless internet protocol address accompanying the log in information is collected. The incentive identification information is retrieved if the first wireless internet protocol address matches the second internet protocol address. An incentive specified by the incentive identification information is then downloaded to the wireless client device.

A non-transitory computer readable storage medium includes executable instructions to receive an incentive request from a wireless client device. Incentive balance information is checked. The incentive balance information is delivered to the wireless client device. A personal identification and a specified incentive amount received from the wireless client device is verified. An authorization code for the specified incentive amount is produced. The authorization code is delivered to the wireless client device.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations performed in accordance with an embodiment of the invention.

FIG. 3 illustrates processing operations performed in accordance with another embodiment of the invention.

Like reference numerals refer to corresponding parts throughout the several views of the drawings.

### DETAILED DESCRIPTION OF THE INVENTION

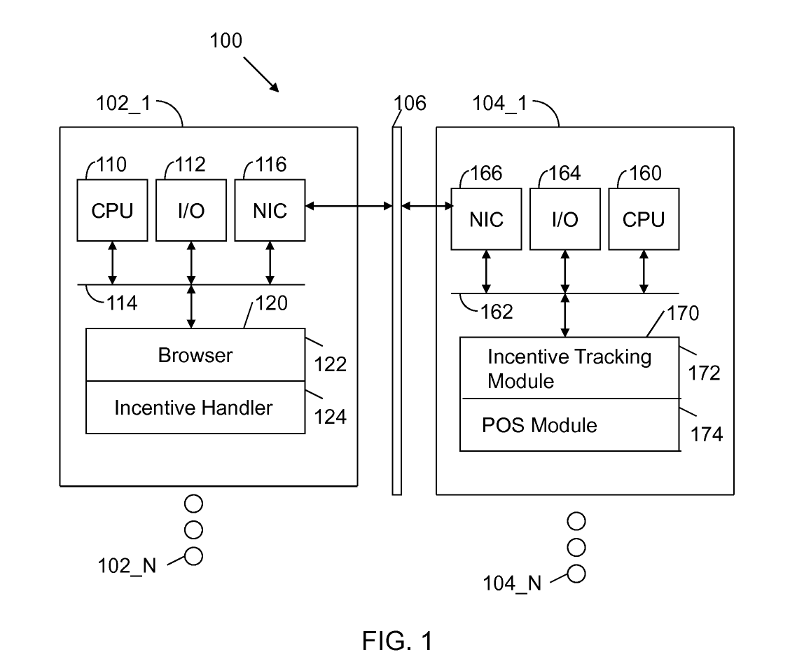

FIG. 1 illustrates a system 100 configured in accordance with an embodiment of the invention. The system 100 includes a set of wireless client devices 102_1 through 102_N and one or more servers 104_1 through 104_N. The client devices 102 and servers 104 communicate over a wireless transmission channel 106.

Each client device 102 is a wireless mobile device (e.g., a smart phone, personal digital assistant, tablet and the like) with standard components, such as a central processing unit 110 connected to input/output devices 112 via a bus 114. The input output devices may include a keyboard, touch display, speaker and the like. A network interface circuit 116 provides a wireless interface to the transmission channel 106.

A memory 120 is also connected to the bus 114. The memory stores a browser 122. As discussed below, the browser 122 may be used to download an incentive handler 124, which operates to receive, organize and redeem incentives. The incentive handler 124 is also referred to herein as a wireless incentive redemption session application.

The server 104 also includes standard components, such as a central processing unit 160, bus 162, input/output devices 164 and a network interface circuit 166. A memory 170 is connected to the bus 162. The memory 170 stores executable instructions to implement operations of the invention. In one embodiment, the memory 170 stores an incentive tracking module 172, which includes executable instructions to coordinate the distribution, tracking and redemption of incentives. The memory 170 also stores a point of sale module 174. The point of sale module 174 includes executable instructions to allow a retailer to process an incentive without the use of any unique point of sale equipment. Rather, the point of sale module 174 interacts with a client device in such a way as to allow the retailer to process a redeemed incentive utilizing information on the client device, as discussed below.

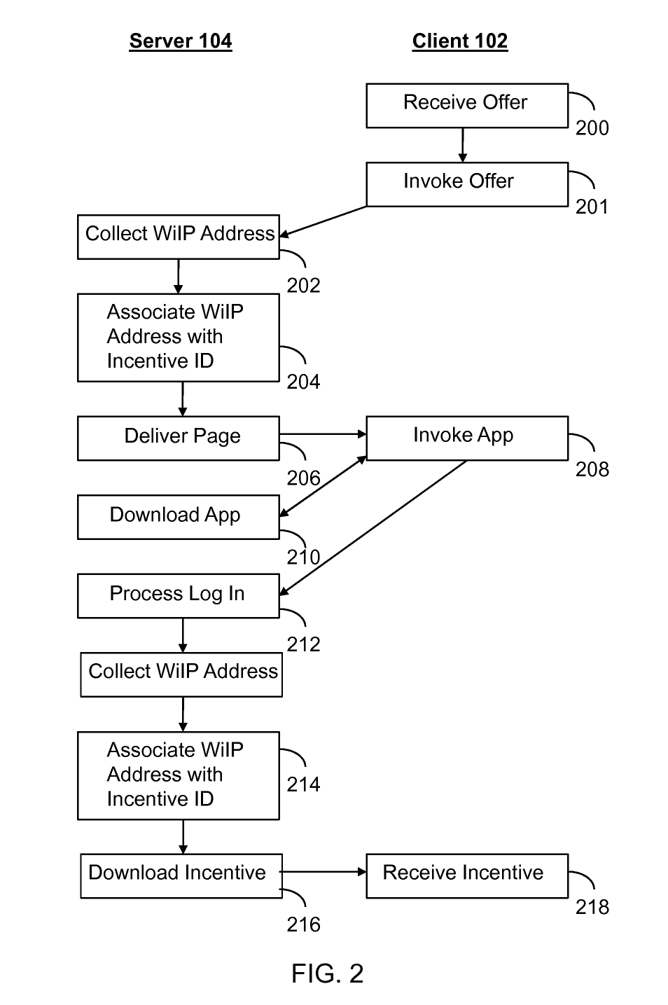

FIG. 2 illustrates processing operations associated with the incentive tracking module 172. Initially, a client 102 receives an offer 200. The offer may be in the form of a banner advertisement, a text advertisement in an email, and/or a delivered web page. In any manifestation, the offer includes a link (e.g., a hypertext transport protocol link) to additional information. A consumer invokes the link 201. The link specifies a location on server 104. The link causes a script to execute on the server. The script extracts the wireless IP address of the mobile device 202. This wireless IP address is associated with incentive identification information 204. The incentive identification information 204 may include a promotional offer identification, an affiliate publisher code and/or other data associated with the incentive. Thus, at this point the incentive tracking module has an identifier in the form of a wireless IP address and corresponding incentive identification information.

The next operation of FIG. 2 is to deliver a landing page 206 to the client 102. The landing page queries the client to determine if the client has an incentive handler application. The application is invoked 208 in one of two ways. If the application is absent, then it is downloaded 210 and executed. The application may be downloaded from server 104 or another server, such as an app store operated by a third-party.

If the application is present, it is executed and prompts the user for log in credentials, which are passed to the server. Observe at this point that the client has expressed interest in an offer or incentive, which was initially manifested by invoking the offer at block 201. This simple act is conducive to impulse shopping. This simple act also leads to an operation of invoking an application at block 208. As indicated at block 210, the application may be downloaded if not already present. Users are commonly weary of downloading an application, but in this instance it is part of a self-serving act of redeeming an incentive and therefore there is an immediate built-in award for utilizing the application. This promotes distribution of the application.

The server 104 subsequently processes the log in information 212. The log in information may include an email address and password. The server also collects the wireless IP address associated with the log in information. The wireless IP address is used to correlate the earlier request with the personal credentials of the email address and password, which can then be associated with incentive identification information. Typically, the time window between receiving the initial wireless IP address and the subsequent wireless IP address associated with the log in information is relatively small and therefore the two actions can be reliably correlated. A time window threshold may be specified and controlled by the incentive tracking module 172.

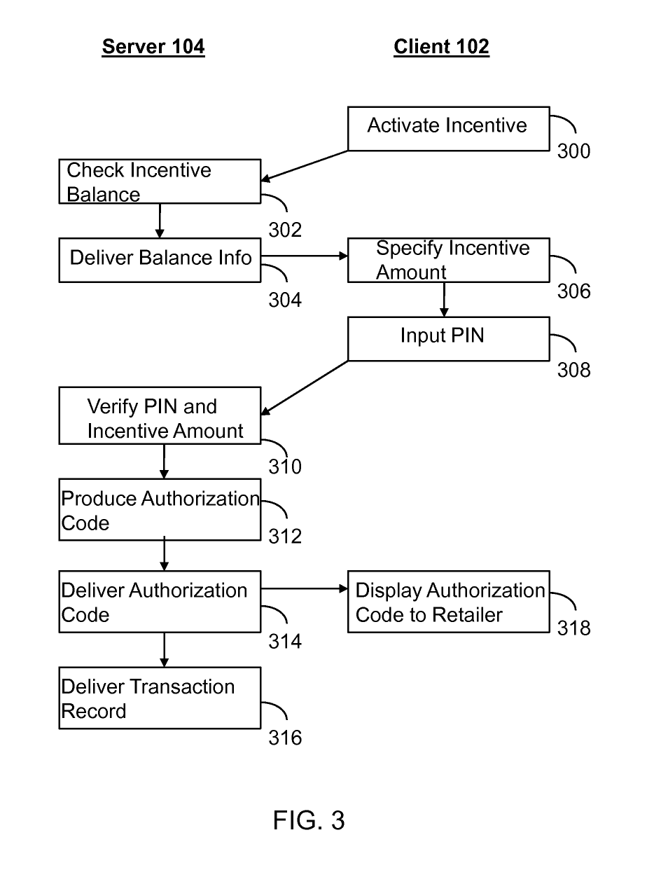

At this point, the server 104 downloads the incentive 216 to the client 102, which receives the incentive 218. The download may be by email or a web based page. Regardless of form, the incentive includes a link, as discussed in connection with FIG. 3.

Observe that the incentive tracking module 172 operates to track activity associated with an offer. Thus, the module supports pay-for-performance business activities. This fosters promotional offer distribution. Advantageously, the offers may appear in emails, text messages, blogs, web sites and a variety of applications. The offers simply need to be associated with a link to the incentive tracking module 172.

FIG. 3 illustrates processing operations associated with redeeming the incentive at a point of sale. Initially, the incentive is activated 300, for example, by activating the link. The link calls the server 104. The link may include an email address and incentive information, which is processed by the server 104 to check an incentive balance 302. For example, the incentive may be a $15 credit at a specified retailer. This credit may be redeemed in one or several transactions. The server delivers balance information 304 to the client 102. The user of client 102 then specifies the amount to be redeemed in a transaction 306. This amount is accompanied by personal identification information 308 (e.g., the password previously collected by the incentive handler application).

The server 104 subsequently verifies the personal identification and incentive amount 310, as received from the client 102. If the personal identification is correct and the incentive amount is appropriate, the remaining balance of the incentive is updated, and an authorization code is produced 312. The authorization code is then delivered to the client 314. Optionally, a transaction record may also be delivered (e.g., by email) to one or more recipients designated by the retailer.

The authorization code is then displayed to the retailer 318. For example, the authorization code may be used by the retailer to provide a discount to the consumer equivalent to the incentive. The retailer may subsequently submit the authorization code to the server 104 to reconcile the transaction and receive a credit equivalent to the discount provided to the consumer.

Observe then that the retailer does not need any specialized point of sale equipment to effectuate utilization of the incentive by the consumer. Rather, the retailer may simply rely upon the authorization code provided to the client device 102. The point of sale module 174 may be used to generate incentive numbers and manage balances associated with incentives. This is accomplished without the retailer installing any special equipment or computer programs. Thus, there is no need for hardware or software integration at the merchant's establishment.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

In the claims:

1. A non-transitory computer readable storage medium, comprising executable instructions to:
collect a first wireless internet protocol address associated with a wireless client device that initiates an invoked offer;
associate the first wireless internet protocol address with incentive identification information corresponding to the invoked offer;
deliver an application invocation page to the wireless client device;
receive log in information from the wireless client device;
collect a second wireless internet protocol address accompanying the log in information;
retrieve the incentive identification information if the first wireless internet protocol address matches the second internet protocol address; and
download to the wireless client device an incentive specified by the incentive identification information.

2. The non-transitory computer readable storage medium of claim 1 further comprising executable instructions to download a wireless incentive redemption session application to the wireless client device.

3. The non-transitory computer readable storage medium of claim 2 further comprising executable instructions to communicate with the wireless incentive redemption session application to collect the log in information.

4. A non-transitory computer readable storage medium, comprising executable instructions to:
receive an incentive request from a wireless client device;
check incentive balance information;
deliver the incentive balance information to the wireless client device;
verify a personal identification and a specified incentive amount received from the wireless client device;
produce an authorization code for the specified incentive amount; and deliver the authorization code to the wireless client device.

5. The non-transitory computer readable storage medium of claim 4 further comprising executable instructions to reconcile a transaction based upon the authorization code received from a retailer.

6. The non-transitory computer readable storage medium of claim 4 further comprising executable instructions to deliver a transaction record.
